(19) United States
(12) Patent Application Publication
(10) Pub. No.: US 2025/0087715 A1
(43) Pub. Date: Mar. 13, 2025

(54) UNITIZED UNIT CELL FOR FUEL CELL STACK

(71) Applicants: Hyundai Motor Company, Seoul (KR); Kia Corporation, Seoul (KR)

(72) Inventor: Jong Hyeok Noh, Ansan-si (KR)

(21) Appl. No.: 18/412,936

(22) Filed: Jan. 15, 2024

(30) Foreign Application Priority Data
Sep. 13, 2023 (KR) 10-2023-0121791

(51) Int. Cl. H01M 8/0258; H01M 4/88; H01M 8/00; H01M 8/0267; H01M 8/0276; H01M 8/1004; H01M 8/1018

(52) U.S. Cl. CPC H01M 8/0258; H01M 4/8807; H01M 8/0267; H01M 8/0276; H01M 8/1004; H01M 8/1018; H01M 8/006; H01M 2300/0082

(57) ABSTRACT

In an embodiment, a unitized unit cell for a fuel cell stack includes an insert including a membrane-electrode assembly in which a first electrode layer is formed on a first surface and a second electrode layer is formed on a second surface, and a pair of gas diffusion layers are disposed on both surfaces. The cell can further include a sheet frame formed through bonding of plural sheets, configured to surround a border of the insert, bonded at a border of the insert and an interface thereof, and having a discharge flow field formed therein along a length direction proximate an edge in a width direction to discharge generated water generated from the insert, and a pair of separation plates having flow fields formed on both surfaces of the sheet frame and configured to supply a reaction gas and to discharge the generated water generated by a reaction.

### CROSS-REFERENCE TO RELATED APPLICATIONS

This application claims the benefit of Korean Patent Application No. 10-2023-0121791, filed on Sep. 13, 2023, which application is hereby incorporated herein by reference.

### TECHNICAL FIELD

The present disclosure relates to a unitized unit cell for a fuel cell stack.

### BACKGROUND

A fuel cell is a kind of power generation device, which converts chemical energy contained in fuel into electrical energy through an electrochemical reaction in a stack, and the fuel cell may be used to not only supply a driving power for industry, home, and vehicle but also supply the power to a small electronic product, such as a portable device, and recently, the usage area thereof has been gradually extended as a high-efficiency clean energy source.

A unit cell of a general fuel cell has a membrane-electrode assembly (MEA) positioned on an innermost side thereof, and the membrane-electrode assembly is composed of a polymer electrolyte membrane capable of moving protons, and catalyst layers applied onto both surfaces of the electrolyte membrane so that hydrogen and oxygen can react, that is, an anode and a cathode.

Further, a gas diffusion layer (GDL) is laminated on an outer part of the membrane-electrode assembly, that is, on an outer part where the anode and the cathode are positioned, and a separation plate, on which a flow field is formed, is positioned on the outer side of the gas diffusion layer so as to supply a fuel and to discharge water generated by the reaction.

A plurality of unit cells composed of the above-described configurations constitute a fuel cell stack through being laminated in series for the fuel cell to generate an output of a desired level. The fuel cell stack includes an end plate combined on the outermost side of the unit cells to support and fix the plurality of unit cells.

Meanwhile, in the related art, for sealing maintenance of the unit cells and convenience in a laminating process thereof, a membrane-electrode-gasket assembly (MEGA) in which the membrane-electrode assembly and the gasket are unitized may have been produced and used.

Further, research for an all-in-one frame in which the membrane-electrode-gas diffusion layer assembly (electricity generating assembly (EGA)), where the gas diffusion layer is bonded onto the membrane-electrode assembly, and the gasket are unitized have recently been made.

One of the results of such research is to produce an elastomer frame that surrounds the border of the membrane-electrode-gasket assembly (MEGA).

However, the elastic body frame is made by producing a sheet-shaped frame by using a heat-sealable thermoplastic elastomer (TPE) and then bonding the frame onto the membrane-electrode-gasket assembly (MEGA) through heat fusion, and in this case, there is a problem in that the membrane-electrode-gasket assembly (MEGA) is damaged or the elastomer frame is deformed due to heat and pressure that are provided during the heat fusion for the bonding.

Further, because the elastomer frame is bonded onto the separation plate made of a metal material through the heat fusion of the elastomer frame, a problem occurs, in which the bonding of the separation plate and the elastomer frame is unable to be performed at the desired level. As a result, in producing the fuel cell stack through lamination of the unit cells, there occurs a problem in aligning the unit cells.

Meanwhile, in case of the fuel cell, there occurs a problem in that the water generated by the chemical reaction is gathered in an outer area of the reaction area to cause the membrane-electrode assembly (MEA) to corrode.

Since the corrosion of the membrane-electrode assembly (MEA) greatly affects durability of the fuel cell, it should be necessarily prevented.

In general, a groove structure for draining water is often formed to effectively discharge the generated water from the fuel cell. However, in case of discharging the generated water through forming of a groove for discharging the generated water on the membrane-electrode assembly (MEA) or the gas diffusion layer (GDL), or gathering the generated water on the metal separation plate, there is a problem in that the generated water still remains on the reaction area.

Further, there are disadvantages that it may be very difficult to actually implement production of the groove structure on a thin layer, such as the membrane-electrode assembly (MEA) or the gas diffusion layer (GDL), and the reaction area may be changed in case of producing the structure through forming on the metal separation plate.

The foregoing description of the background technology is intended merely to help the understanding of the background of the present disclosure, and is not intended to mean that the present disclosure falls within the purview of the related art that is already publicly known.

### SUMMARY

The present disclosure relates to a unitized unit cell for a fuel cell stack, and more particularly, to a unitized unit cell for a fuel cell stack that can smoothly discharge generated water.

An embodiment of the present disclosure provides a unitized unit cell for a fuel cell stack, which can bond and unitize a membrane-electrode-gasket assembly (MEGA) and a pair of separation plates through production of a sheet frame having a three-dimensional (3D) shape by producing a plurality of sheets using a hard plastic material, punching out a specified shape on each of the plurality of sheets, and bonding the respective sheets.

In particular, an embodiment of the present disclosure provides a unitized unit cell for a fuel cell stack in which a discharge flow field for discharging generated water is formed inside a sheet frame.

The technical problems to be solved by an embodiment of the present disclosure are not necessarily limited to the above-mentioned technical problems, and it can be interpreted that other unmentioned technical problems can be clearly understood by those of ordinary skill in the art to which the present disclosure pertains from the description of embodiments of the present disclosure.

A unitized unit cell for a fuel cell stack according to an embodiment of the present disclosure includes an insert composed of a membrane-electrode assembly in which a first electrode layer is formed on one surface of a polymer electrolyte membrane and a second electrode layer is formed on the other surface of the polymer electrolyte membrane. An embodiment further includes a pair of gas diffusion layers disposed on both surfaces of the membrane-electrode assembly, a sheet frame formed through bonding of a plurality of sheets, disposed to surround a border of the insert in an outer area of the insert, bonded at the border of the insert and an interface thereof, and having a discharge flow field formed therein along a length direction at an edge in a width direction to discharge generated water generated from the insert. An embodiment further includes a pair of separation plates having flow fields formed on both surfaces of the sheet frame and configured to supply a reaction gas and to discharge the generated water generated by a reaction.

In an embodiment, the sheet frame includes a first base sheet and a second base sheet each having a center area on which a first insert through-hole that is disposed as a border of the insert is seated is formed, and a first flow field sheet bonded between the first base sheet and the second base sheet and having a center area on which a second insert through-hole communicating with the first insert through-hole is formed, wherein the discharge flow field is formed on the first flow field sheet.

In an embodiment, the first base sheet and the second base sheet, a plurality of first manifold through-holes are formed on one side in a length direction based on the first insert through-hole and configured to make a reaction gas and a cooling water flow in and out, and a plurality of second manifold through-holes are formed on the other side in the length direction and configured to make the reaction gas and the cooling water flow in and out. In an embodiment, on the first flow field sheet, a plurality of third manifold through-holes communicating with the plurality of first manifold through-holes are formed on one side in a length direction based on the second insert through-hole, and a plurality of fourth manifold through-holes communicating with the second manifold through-holes are formed on the other side in the length direction, and the discharge flow field is a first discharge flow field communicating with any one of the plurality of third manifold through-holes from a position that is adjacent to the second insert through-hole on the first flow field sheet.

In an embodiment, the pair of gas diffusion layers are divided into a first gas diffusion layer facing a first electrode layer of the membrane-electrode assembly and a second gas diffusion layer facing a second electrode layer of the membrane-electrode assembly. In an embodiment, the pair of separation plates are divided into a first separation plate facing the first gas diffusion layer and a second separation plate facing the second gas diffusion layer, and the first discharge flow field communicates with any one of the plurality of first manifold through-holes in an area where the first gas diffusion layer and the first separation plate come in contact with each other.

In an embodiment, the first discharge flow field is divided into a first main discharge flow field formed along a length direction at an edge in a width direction of the sheet frame and having an end part communicating with any one of the plurality of third manifold through-holes, and a plurality of first branched discharge flow fields spaced apart at a specified interval from the first main discharge flow field along a length direction and branched toward the second insert through-hole.

In an embodiment, the first main discharge flow field communicates with the third manifold through-hole positioned at a lowermost end based on a gravity direction among the plurality of third manifold through-holes.

In an embodiment, the second insert through-hole is formed so that an edge thereof is larger than the first insert through-hole as much as a specified width. In an embodiment, a step part is formed as much as a thickness of the first flow field sheet due to a size difference between the second insert through-hole and the first insert through-hole as the first base sheet, the second base sheet, and the first flow field sheet are bonded. In an embodiment, an edge of the insert is bonded onto the step part.

In the unitized unit cell for a fuel cell stack according to an embodiment of the present disclosure, the sheet frame is composed of a first base sheet and a second base sheet each having a center area on which a first insert through-hole that is disposed as a border of the insert is seated is formed, and a first flow field sheet and a second flow field sheet each having a center area on which a second insert through-hole communicating with the first insert through-hole is formed, wherein the first flow field sheet is bonded between the first base sheet and the second base sheet, the second flow field sheet is bonded onto an outer surface of the second base sheet, and the discharge flow field is divided into a first discharge flow field formed on the first flow field sheet and a second discharge flow field formed on the second flow field sheet.

In an embodiment, on each of the first base sheet and the second base sheet, a plurality of first manifold through-holes are formed on one side in a length direction based on the first insert through-hole and configured to make a reaction gas and a cooling water flow in and out, and a plurality of second manifold through-holes are formed on the other side in the length direction and configured to make the reaction gas and the cooling water flow in and out. In an embodiment, on each of the first flow field sheet and the second flow field sheet, a plurality of third manifold through-holes communicating with the plurality of first manifold through-holes are formed on one side in a length direction based on the second insert through-hole, and a plurality of fourth manifold through-holes communicating with the second manifold through-holes are formed on the other side in the length direction. In an embodiment, the discharge flow field is a first discharge flow field communicating with any one of the plurality of third manifold through-holes from a position that is adjacent to the second insert through-hole on the first flow field sheet, and a second discharge flow field communicating with any one of the plurality of fourth manifold through-holes from a position that is adjacent to the second insert through-hole on the second flow field sheet.

In an embodiment, the pair of gas diffusion layers are divided into a first gas diffusion layer facing a first electrode layer of the membrane-electrode assembly and a second gas diffusion layer facing a second electrode layer of the membrane-electrode assembly. In an embodiment, the pair of separation plates are divided into a first separation plate facing the first gas diffusion layer and a second separation plate facing the second gas diffusion layer. In an embodiment, the first discharge flow field communicates with any one of the plurality of third manifold through-holes in an area where the first gas diffusion layer and the first separation plate come in contact with each other, and the second discharge flow field communicates with any one of the plurality of fourth manifold through-holes in an area where the second gas diffusion layer and the second separation plate come in contact with each other.

In an embodiment, the first discharge flow field is divided into a first main discharge flow field formed along a length direction at an edge in a width direction of the sheet frame and having an end part communicating with any one of the plurality of third manifold through-holes, and a plurality of first branched discharge flow fields spaced apart at a specified interval from the first main discharge flow field along a length direction and branched toward the second insert through-hole.

In an embodiment, the second discharge flow field is divided into a second main discharge flow field formed along a length direction at an edge in a width direction of the sheet frame and having an end part communicating with any one of the plurality of fourth manifold through-holes, and a plurality of second branched discharge flow fields spaced apart at a specified interval from the second main discharge flow field along a length direction and branched toward the second insert through-hole.

In an embodiment, the first main discharge flow field communicates with the third manifold through-hole positioned at a lowermost end based on a gravity direction among the plurality of third manifold through-holes, and the second main discharge flow field communicates with the fourth manifold through-hole positioned at a lowermost end based on a gravity direction among the plurality of fourth manifold through-holes.

In an embodiment, the first discharge flow field and the second discharge flow field are independently formed at positions opposite to each other based on the second base sheet.

In an embodiment, on any one of the pair of separation plates, a sealing gasket surrounding an area where the insert is disposed is provided, and the discharge flow field is formed between an outermost angle of the insert and a position where the sealing gasket is provided.

In an embodiment, the sheet frame is formed of an engineering plastic or a super engineering plastic having a thermal expansion coefficient equal to or smaller than 40.

In an embodiment, because the flow of the generated water generated in the reaction area is guided to the inside of the sheet frame that is the area excluding the reaction area, the corrosion of the MEA and the separation plate can be prevented.

In an embodiment, because the discharge flow field for flowing of the generated water directly communicates with the manifold through-hole without being connected to the diffusion area, the reaction gas supply and distribution in the diffusion area can be accurately predicted, and thus uniform distribution of the reaction gas can be expected in the reaction area.

In an embodiment, because the structure for discharging the generated water is formed inside the sheet frame, it is not necessary to separately form an additional structure for discharging the generated water on the metal separation plate.

In an embodiment, because additional structure change of the metal separation plate is not necessary, the reaction area can be maintained as much as possible.

In an embodiment, because the discharge flow field for discharging the generated water is formed on the sheet frame, the 3D structural discharge flow field can be easily implemented in various forms even through the simple change of the forms and punching patterns of the respective sheets forming the sheet frame.

### BRIEF DESCRIPTION OF THE DRAWINGS

The above and other features and advantages of embodiments of the present disclosure can be more clearly understood from the following detailed description taken in conjunction with the accompanying drawings, in which:

FIG. 1 is a diagram showing a unitized unit cell for a fuel cell stack according to an embodiment of the present disclosure;

FIG. 2 is a diagram unfolding and showing the constitution of a unitized unit cell for a fuel cell stack according to an embodiment of the present disclosure;

FIG. 3 is a diagram unfolding and showing the constitution of a sheet frame that constitutes a unitized unit cell for a fuel cell stack according to an embodiment of the present disclosure;

FIGS. 4A and 4B are diagrams showing main part cross sections of a unitized unit cell for a fuel cell stack according to an embodiment of the present disclosure;

FIG. 5 is a diagram showing a unitized unit cell for a fuel cell stack according to an embodiment of the present disclosure;

FIG. 6 is a diagram unfolding and showing the constitution of a sheet frame that constitutes a unitized unit cell for a fuel cell stack according to an embodiment of the present disclosure; and

FIGS. 7A and 7B are diagrams showing main part cross sections of a unitized unit cell for a fuel cell stack according to an embodiment of the present disclosure.

### DETAILED DESCRIPTION OF ILLUSTRATIVE EMBODIMENTS

Hereinafter, embodiments disclosed in the description will be described in detail with reference to the accompanying drawings, and same reference numerals can be given to the same or similar constituent elements regardless of the reference numerals, and the duplicate explanation thereof can be omitted.

Suffixes “module” and “part” for constituent elements as used in the following description are given or can be used interchangeably for ease of preparation of the description, and do not necessarily have distinguishable meanings or roles by themselves.

In explaining embodiments disclosed in the present specification, if it is determined that the detailed explanation of related known technology may obscure the gist of embodiments disclosed in the present specification, the detailed explanation can be omitted. Further, the accompanying drawings can help in understanding embodiments of the present specification, and it can be understood that the technical ideas disclosed in the present specification are not necessarily limited by the accompanying drawings, but include all changes, equivalents, and substitutes included in the ideas and technical scope of the present disclosure.

The terms including ordinal numbers, such as “first, second, and the like”, may be used to describe diverse constituent elements, but the constituent elements are not necessarily limited by the terms. Such terms can be only for the purpose of discriminating one constituent element from another constituent element.

If a certain constituent element is mentioned to be “connected” or “coupled” to another constituent element, it can be understood that the certain constituent element is directly connected or coupled to the other constituent element and/or still another constituent element may exist in the middle. In contrast, if a certain constituent element is mentioned to be “directly connected” or “directly coupled” to another constituent element, it can be understood that the still another constituent element does not exist in the middle.

A singular expression can include a plural expression unless clearly defined in a different manner in context.

In the present specification, it should be understood that the term “include” or “have” specifies the presence of stated features, numerals, steps, operations, constituent elements, parts, or a combination thereof, but does not preclude the possibility of the presence or addition of one or more other features, numerals, steps, operations, constituent elements, parts, or a combination thereof.

First, an embodiment of a unitized unit cell for a fuel cell stack to which a sheet frame is applied will be described.

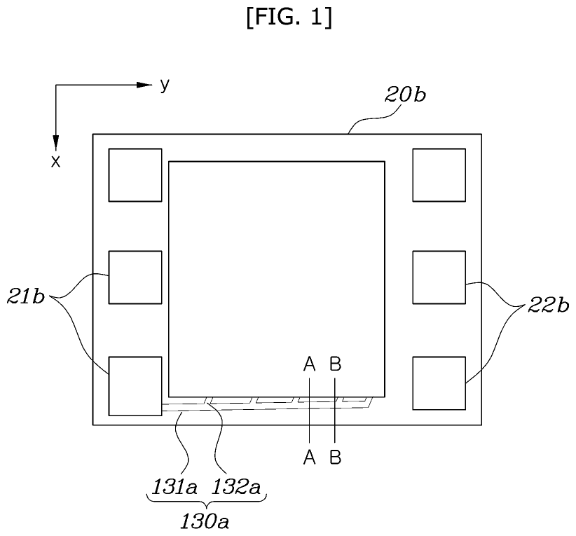

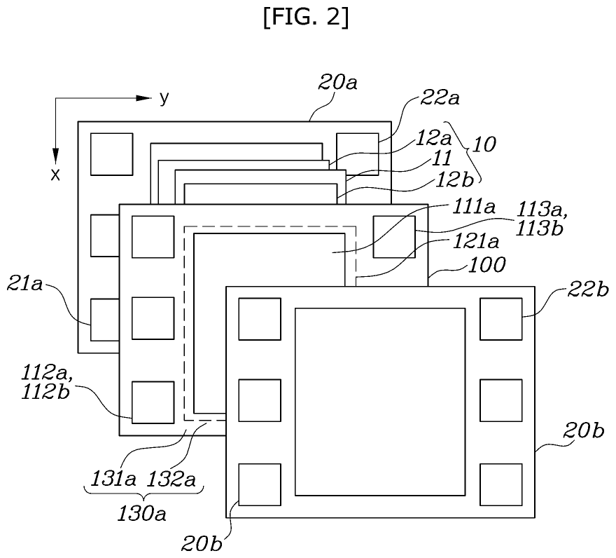

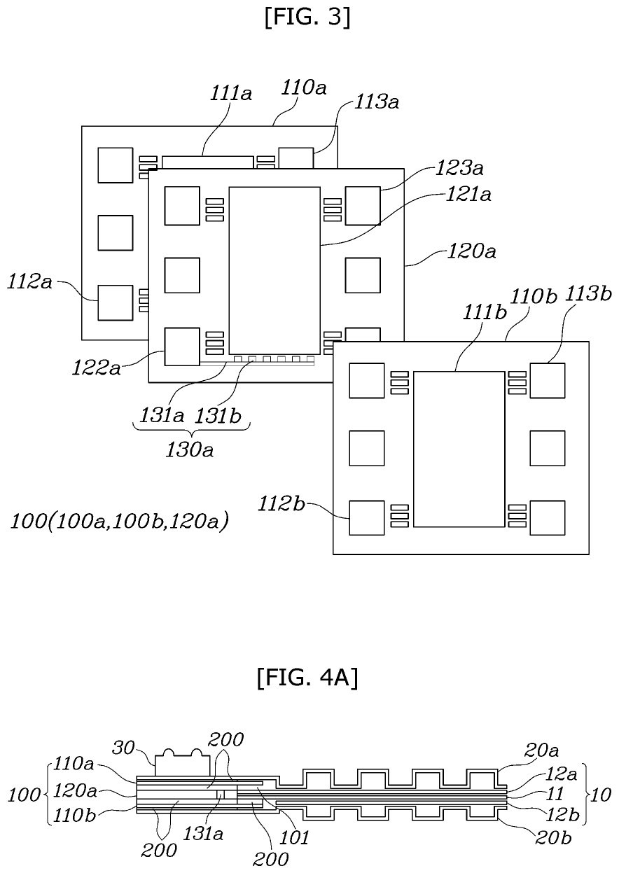

FIG. 1 is a diagram showing a unitized unit cell for a fuel cell stack according to an embodiment of the present disclosure. FIG. 2 is a diagram unfolding and showing the constitution of a unitized unit cell for a fuel cell stack according to an embodiment of the present disclosure. FIG. 3 is a diagram unfolding and showing the constitution of a sheet frame that constitutes a unitized unit cell for a fuel cell stack according to an embodiment of the present disclosure.

As illustrated in FIGS. 1 to 3, a unitized unit cell for a fuel cell stack can be provided with a membrane-electrode-gas diffusion layer assembly (electricity generating assembly (EGA) (hereinafter, referred to as an insert 10) in which a membrane-electrode assembly 11, having a first electrode layer formed on one surface of a polymer electrolyte membrane and a second electrode layer formed on the other surface thereof, and a pair of gas diffusion layers 12a and 12b located on both surfaces of the membrane-electrode assembly 11 are bonded. The unitized unit cell can have a sheet frame 100 formed through bonding of a plurality of sheets, positioned to surround a border of the insert 10 in an outer area of the insert 10, and bonded at the border of the insert 10 and an interface thereof. The unitized unit cell can have a pair of separation plates 20a and 20b having flow fields formed on both surfaces of the sheet frame 100 and configured to supply a reaction gas and to discharge the generated water generated by a reaction. The insert 10, the sheet frame 100, and the pair of separation plates 20a and 20b can be bonded by an adhesive member 200 at respective interfaces thereof.

In an embodiment, the insert 10 is an assembly obtained by laminating the membrane-electrode assembly 11 and the pair of gas diffusion layers 12a and 12b, and preferably, the gas diffusion layers 12a and 12b are positioned and laminated on one surface and the other surface of the membrane-electrode assembly 11. The membrane-electrode assembly 11 can be composed of a polymer electrolyte membrane capable of moving protons, and catalyst layers applied onto both surfaces of the electrolyte membrane so that hydrogen and oxygen can react, that is, a first electrode layer and a second electrode layer. The first electrode layer may be a cathode, and the second electrode layer may be an anode. Of course, the first electrode layer and the second electrode layer are not necessarily limited thereto, and the first electrode layer may be an anode, and the second electrode layer may be a cathode.

The pair of gas diffusion layers 12a and 12b constituting the insert 10 can be divided into a first gas diffusion layer 12a facing a first electrode layer of the membrane-electrode assembly 11 and a second gas diffusion layer 12b facing a second electrode layer of the membrane-electrode assembly 11. The first gas diffusion layer 12a and the second gas diffusion layer 12b may be formed with the same size as the size of the membrane-electrode assembly. However, in an embodiment, for solid bonding onto the membrane-electrode assembly 11 and the sheet frame 100, it can be preferable that any one of the first gas diffusion layer 12a and the second gas diffusion layer 12b is formed with the same size as the size of the membrane-electrode assembly 11, and the other thereof is formed with a size that is slightly smaller than the size of the membrane-electrode assembly 11. For example, the first gas diffusion layer 12a can be formed with the same size as the size of the membrane-electrode assembly 11, and the second gas diffusion layer 12b can be formed with a size that is slightly smaller than the size of the membrane-electrode assembly 11.

Accordingly, the first gas diffusion layer 12a can be exposed through one surface of the border of the insert 10, and the edge of the membrane-electrode assembly 11 can be exposed through the other surface of the border of the insert 10.

The sheet frame 100 can be a structure for being integrally formed on the outer area of the insert 10 for seal maintenance of the insert 10 and convenience in a lamination process, and the sheet frame 100 can be formed through bonding of a plurality of sheets injected in a specified shape, and the respective sheets can be bonded together by a separate adhesive member 200. In an embodiment, it can be preferable that the sheet frame 100 is formed of a hard plastic material having a similar thermal expansion coefficient to that of the separation plates 20a and 20b made of a metal material. For example, the plastic material that is applied to the sheet frame 100 may be an engineering plastic or a super engineering plastic having a thermal expansion coefficient equal to or smaller than 40.

Further, as the adhesive member 200, an adhesive or an adhesive sheet may be applied.

The sheet frame 100 may be positioned to face any one of both surfaces of the border of the insert 10 in the outer area of the insert 10. The sheet frame 100 can be positioned to face the other surface of both surfaces of the border of the insert 10, that is, a region with an exposed edge of the membrane-electrode assembly 11. Accordingly, the sheet frame 100 and the edge of the membrane-electrode assembly 11 constituting the insert 10 can be bonded by the adhesive member 200.

The “outer area” of the insert 10 can be an area including an edge area of the insert 10 and a surrounding space, and the “border” of the insert 10 can be the edge area of the insert 10, for example.

The sheet frame 100 can be configured to surround the outer area of the insert 10 while facing the other surface of the border of the insert 10. In an embodiment, an area facing the insert 10 may be formed on the sheet frame 100 for airtight bonding onto the insert 10.

Further, the sheet frame 100 can be formed through bonding of a plurality of sheets.

In an embodiment of the present embodiment, the sheet frame 100 is formed through bonding of three sheets, and for example, the sheet frame 100 can be composed of a first base sheet 110a and a second base sheet 110b, each having a center area on which a first insert through-hole 111a or 111b that is configured as the border of the insert 10 is seated. The sheet frame 100 can be further composed of a first flow field sheet 120a bonded between the first base sheet 110a and the second base sheet 110b and having a center area on which a second insert through-hole 121a communicating with the first insert through-hole 111a or 111b. Accordingly, the sheet frame 100 can be formed through bonding by the adhesive member 200 in a state where the first flow field sheet 120a is located between the first base sheet 110a and the second base sheet 110b.

Further, a plurality of manifold through-holes for forming a manifold that makes the reaction gas and the cooling water flow in/out of the reaction area can be formed by the insert 10. The membrane-electrode assembly 11 and the gas diffusion layers 12a and 12b can be formed on the sheet frame 100.

For example, on each of the first base sheet 110a and the second base sheet 110b, a plurality of first manifold through-holes 112a and 112b can be formed on one side in a length direction based on the first insert through-hole 111a or 111b and configured to make a reaction gas and a cooling water flow in and out, and a plurality of second manifold through-holes 113a and 113b can be formed on the other side in the length direction and configured to make the reaction gas and the cooling water flow in and out.

Further, on the first flow field sheet 120a, a plurality of third manifold through-holes 122a communicating with the plurality of first manifold through-holes 112a and 112b can be formed on one side in a length direction based on the second insert through-hole 121a, and a plurality of fourth manifold through-holes 123a communicating with the second manifold through-holes 113a and 113b can be formed on the other side in the length direction.

Further, inside the sheet frame 100, a discharge flow field 130 can be formed to discharge generated water being generated from the insert 10 along a length direction at an edge in a width direction.

The length direction of the sheet frame 100 can be a direction in which the reaction gas and cooling water flow on the sheet frame 100, and the width direction of the sheet frame 100 to be described later can be a direction that is vertical to the length direction of the sheet frame 100. In some of the drawings, the length direction can be a “y” direction, and the width direction can be an “x” direction.

The pair of separation plates 20a and 20b can be structures provided to supply the reaction gas onto both surfaces of the sheet frame 100 and to discharge the generated water generated by the reaction, and can be generally produced as a structure in which lands, playing a supporting role, and channels (flow field), being flow paths of the reaction gas and the generated water, can be repeatedly formed.

The pair of separation plates 20a and 20b can be divided into a first separation plate 20a facing the first gas diffusion layer 12a and a second separation plate 20b facing the second gas diffusion layer 12b.

On each of the pair of separation plates 20a and 20b, lands and channels can be formed on the reaction area on which the insert 10 is positioned, a plurality of fifth manifold through-holes 21a and 21b through which the reaction gas and the cooling water can flow in and out can be formed on one side in the length direction based on the reaction area, and a plurality of sixth manifold through-holes 22a and 22b through which the reaction gas and the cooling water can flow in and out can be formed on the other side in the length direction.

In an embodiment, the plurality of fifth manifold through-holes 21a and 21b formed on the pair of separation plates 20a and 20b and formed to communicate with the plurality of first manifold through-holes 112a and 112b and the third manifold through-hole 122a formed on the sheet frame 100, and the plurality of sixth manifold through-holes 22a and 22b formed on the pair of separation plates 20a and 20b are formed to communicate with the plurality of second manifold through-holes 113a and 113b and the fourth manifold through-hole 123a formed on the sheet frame 100.

Hereinafter, a unitized unit cell for a fuel cell stack according to an embodiment of the present disclosure will be described in more detail with reference to the drawings.

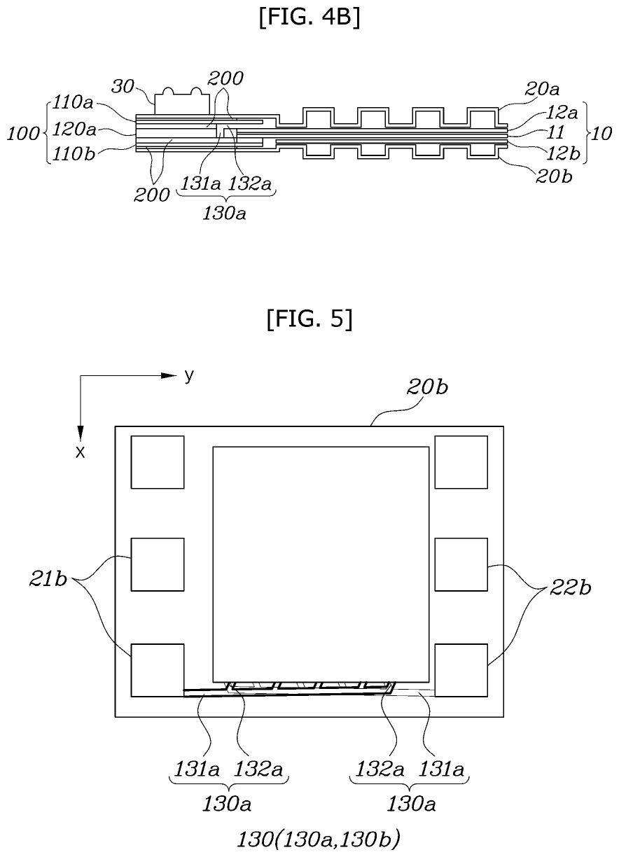

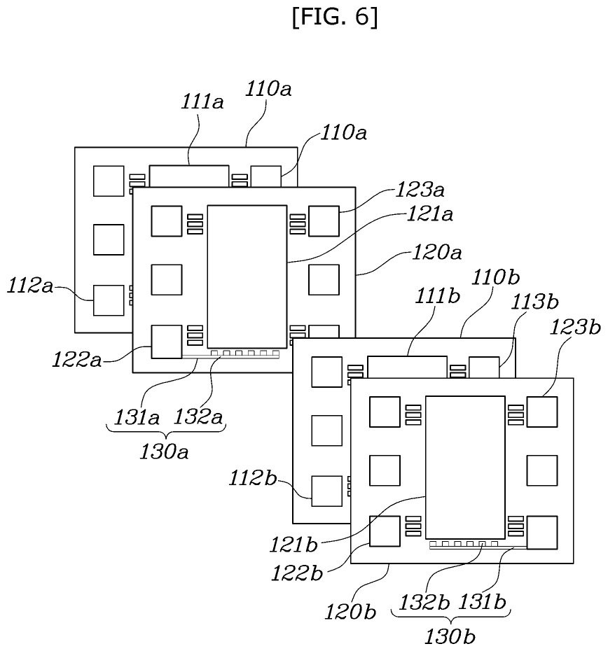

FIGS. 4A and 4B are diagrams showing main part cross sections of a unitized unit cell for a fuel cell stack according to an embodiment of the present disclosure.

FIG. 4A shows a cross section corresponding to line A-A of FIG. 1. FIG. 4B shows a cross section corresponding to line B-B of FIG. 1.

As illustrated in the drawings, in the same manner as the unitized unit cell as described above with reference to FIGS. 1 to 3, the unitized unit cell for a fuel cell stack according to an embodiment of the present disclosure includes an insert 10 composed of a membrane-electrode assembly 11 in which a first electrode layer is formed on one surface of a polymer electrolyte membrane and a second electrode layer is formed on the other surface of the polymer electrolyte membrane, and a pair of gas diffusion layers 12a and 12b disposed on both surfaces of the membrane-electrode assembly 11. The unitized unit cell for a fuel cell stack according to an embodiment of the present disclosure further includes a sheet frame 100 formed through bonding of a plurality of sheets and configured to surround a border of the insert 10 in an outer area of the insert 10, and a pair of separation plates 20a and 20b having flow fields formed on both surfaces of the sheet frame 100 and configured to supply a reaction gas and to discharge the generated water generated by the reaction.

A discharge flow field 130 for discharging the generated water being generated from the insert 10 can be formed inside the sheet frame 100 along a length direction at an edge in a width direction.

Because the insert 10 can have the same constitution as that of the insert 10 constituting the unitized unit cell described above with reference to FIGS. 1 to 3, a duplicate description thereof will be omitted.

In the same manner, because the sheet frame 100 can have a similar constitution to that of the sheet frame 100 constituting the unitized unit cell described above with reference to FIGS. 1 to 3, the duplicate description thereof will be omitted.

As described above, the sheet frame 100 can be formed through bonding by an adhesive member 200 in a state where a first flow field sheet 120a is located between the first base sheet 110a and the second base sheet 110b.

The second insert through-hole 121a formed on the first flow field sheet 120a can be formed so that an edge thereof is larger than the first insert through-hole 111a or 111b formed on the first base sheet 110a and the second base sheet 110b as much as a specified width. Accordingly, a step part 101 can be formed as much as the thickness of the first flow field sheet 120a due to the size difference between the second insert through-hole 121a and the first insert through-hole 111a or 111b, as the first base sheet 110a, the second base sheet 110b, and the first flow field sheet 120a can be bonded. Accordingly, the step part 101 can be formed on an inner periphery of the sheet frame 100.

Accordingly, during bonding of the sheet frame 100 and the insert 10, the edge of the insert 10 can be bonded onto the step part 101 of the sheet frame 100. And in some embodiments, preferably, as the step part 101 of the sheet frame 100 and the membrane-electrode assembly 11 constituting the insert 10 face each other and are bonded by the adhesive member 200, solid bonding and unitization can be made between them.

Further, on the sheet frame 100 may be formed a diffusion area for an inflow or discharge of the reaction gas being diffused among the first manifold through-hole 112a or 112b, the third manifold through-hole 122a, and the first insert through-hole 111a or 111b and among the first insert through-hole 111a or 111b, the second manifold through-hole 113a or 113b, and the fourth manifold through-hole 123a.

At the edge in the width direction of the sheet frame 100 according to an embodiment of the present disclosure, the discharge flow field 130 for discharging the generated water generated from the insert 10 along the length direction is formed inside the sheet frame 100.

The discharge flow field 130 may be formed inside the sheet frame 100 because the sheet frame 100 can be formed by bonding a plurality of sheets. Accordingly, in some embodiments, it is preferable that the discharge flow field 130 is formed on the first flow field sheet 120a that is located between the first base sheet 110a and the second base sheet 110b.

The discharge flow field 130 may be implemented as a first discharge flow field 130a that communicates with any one of a plurality of third manifold through-holes 122a at a position adjacent to the second insert through-hole 121a on the first flow field sheet 120a.

The first discharge flow field 130a may communicate with any one of the plurality of third manifold through-holes 122a in an area where the first gas diffusion layer 12a and the first separation plate 20a come in contact with each other.

Preferably in some embodiments, the first discharge flow field 130a communicates with the third manifold through-hole 122a positioned at a lowermost end based on a gravity direction among the plurality of third manifold through-holes 122a. Further, for smooth discharge of the generated water, the first discharge flow field 130a may be gradually slantingly formed in a lower direction toward the third manifold through-hole 122a at the lowermost end.

Accordingly, when the sheet frame 100 is installed on the fuel cell stack, the first discharge flow field 130a can be formed on a lower part of the sheet frame 100 based on the gravity direction.

The first discharge flow field 130a can be divided into a first main discharge flow field 130 formed along a length direction at an edge in a width direction of the sheet frame 100 and having an end part communicating with any one of the plurality of third manifold through-holes 122a, and a plurality of first branched discharge flow fields 130 spaced apart at a specified interval from the first main discharge flow field 130 along a length direction and branched toward the second insert through-hole 121a.

Accordingly, if the generated water is generated in the reaction area on which the insert 10 is located, and is gathered in the lower part based on the gravity direction due to the self-weight of the generated water, the generated water can flow to the first main discharge flow field 130 through the plurality of first branched discharge flow field 130, and can flow and be discharged through the third manifold through-hole 122a. Accordingly, it is preferable in some embodiments that the third manifold through-hole 122a communicating with the first main discharge flow field 130 is the third manifold through-hole 122a for discharging oxygen (air) that is the reaction gas.

Because hydrogen and oxygen (air) flow independently inside the fuel cell stack, the oxygen (air) can flow on one of both surfaces of the insert 10, and the hydrogen can flow on the other surface even in the unit cell.

Accordingly, for more effective discharge of the generated water, the discharge flow field 130 may further include a second discharge flow field 130b for discharging the generated water through the fourth manifold through-hole 123a for discharging the hydrogen together with the first discharge flow field 130a for discharging the generated water through the third manifold through-hole 122a or 122b for discharging the oxygen (air).

FIG. 5 is a diagram showing a unitized unit cell for a fuel cell stack according to an embodiment of the present disclosure.

As illustrated in FIG. 5, in the same manner as the first discharge flow field 130a, the second discharge flow field 130b can be formed on the lower part of the sheet frame 100 based on the gravity direction when the sheet frame 100 is installed on the fuel cell stack to smoothly discharge the generated water that is gathered on the lower part based on the gravity direction by the self-weight thereof.

Accordingly, the first discharge flow field 130a and the second discharge flow field 130b can be independently formed at corresponding positions inside the sheet frame 100 without communicating with each other.

However, the first discharge flow field 130a and the second discharge flow field 130b can be formed at the corresponding positions to be spaced apart from each other in a thickness direction of the sheet frame 100. In some embodiments, it is preferable that the first discharge flow field 130a and the second discharge flow field 130b are formed in shapes that are symmetrical to each other.

Accordingly, in an embodiment of the present disclosure, the sheet frame 100 is formed through bonding of four sheets, and for example, the sheet frame 100 can be composed of a first base sheet 110a and a second base sheet 110b, each having a center area on which a first insert through-hole 111a or 111b that is configured as the border of the insert 10 is seated. The sheet frame 100 can be further composed of a first flow field sheet 120a and a second flow field sheet 120b having a center area on which a second insert through-hole 121a or 121b communicating with the first insert through-hole 111a or 111b is formed. Accordingly, the sheet frame 100 can be formed in a manner that the first flow field sheet 120a is bonded between the first base sheet 110a and the second base sheet 110b, and the second flow field sheet 120b is bonded together by the adhesive member 200 in a state where the second flow field sheet 120b is positioned on an outer surface of the second base sheet 110b.

On the sheet frame 100, a plurality of manifold through-holes for forming a manifold for making the reaction gas and the cooling water flow in and be discharged from the reaction area can be formed by the insert 10, that is, the membrane-electrode assembly 11 and the gas diffusion layers 12a and 12b, can be formed.

For example, on each of the first base sheet 110a and the second base sheet 110b, a plurality of first manifold through-holes 112a and 112b can be formed on one side in a length direction based on the first insert through-hole 111a or 111b and configured to make the reaction gas and the cooling water flow in and out. And, a plurality of second manifold through-holes 113a and 113b can be formed on the other side in the length direction and configured to make the reaction gas and the cooling water flow in and out.

On the first flow field sheet 120a and the second flow field sheet 120b, a plurality of third manifold through-holes 122a and 122b communicating with the plurality of first manifold through-holes 112a and 112b can be formed on one side in a length direction based on the second insert through-hole 121a and 121b. And, a plurality of fourth manifold through-holes 123a and 123b communicating with the second manifold through-holes 113a and 113b can be formed on the other side in the length direction.

The discharge flow field 130 may be implemented as a first discharge flow field 130a that communicates with any one of a plurality of third manifold through-holes 122a and 122b at a position adjacent to the second insert through-holes 121a and 121b on the first flow field sheet 120a, and a second discharge flow field 130b that communicates with any one of a plurality of fourth manifold through-holes 122a and 122b at a position adjacent to the second insert through-holes 121a and 121b on the second flow field sheet 120b.

The first discharge flow field 130a may communicate with any one of the plurality of third manifold through-holes 122a and 122b in an area where the first gas diffusion layer 12a and the first separation plate 20a come in contact with each other. And, the second discharge flow field 130b may communicate with any one of the plurality of fourth manifold through-holes 123a and 123b in an area where the second gas diffusion layer 12b and the second separation plate 20b come in contact with each other.

Preferably in some embodiments, the first discharge flow field 130a may communicate with the third manifold through-holes 122a and 122b positioned at a lowermost end based on a gravity direction among the plurality of third manifold through-holes 122a and 122b. For smooth discharge of the generated water, the first discharge flow field 130a may be gradually slantingly formed in a lower direction toward the third manifold through-holes 122a and 122b at the lowermost end.

In some embodiments, it is preferable that the second discharge flow field 130a communicates with the fourth manifold through-holes 123a and 123b positioned at the lowermost end based on the gravity direction among the plurality of fourth manifold through-holes 123a and 123b. For smooth discharge of the generated water, the second discharge flow field 130b may be gradually slantingly formed in the lower direction toward the fourth manifold through-holes 123a and 123b at the lowermost end.

Accordingly, when the sheet frame 100 is installed on the fuel cell stack, the first discharge flow field 130a and the second discharge flow field 130b can be formed on the lower part of the sheet frame 100 based on the gravity direction.

The first discharge flow field 130a can be divided into a first main discharge flow field 130 formed along a length direction at an edge in a width direction of the sheet frame 100 and having an end part communicating with any one of the plurality of third manifold through-holes 122a and 122b, and a plurality of first branched discharge flow fields 130 that can be spaced apart at a predetermined or selected interval from the first main discharge flow field 130 along the length direction and branched toward the second insert through-holes 121a and 121b.

The second discharge flow field 130b can be divided into a second main discharge flow field 130 formed along a length direction at an edge in a width direction of the sheet frame 100 and having an end part communicating with any one of the plurality of fourth manifold through-holes 123a and 123b, and a plurality of second branched discharge flow fields 130 that can be spaced apart at a predetermined or selected interval from the second main discharge flow field 130 along the length direction and branched toward the second insert through-holes 121a and 121b.

Accordingly, if the generated water is generated in the reaction area on which the insert 10 is located, and is gathered in the lower part based on the gravity direction due to the self-weight of the generated water, the generated water can flow to the first main discharge flow field 130 or the second main discharge flow field 130 through the plurality of first branched discharge flow field 130 or the second branched discharge flow field 130, and can flow and be discharged through the third manifold through-holes 122a and 122b or the fourth manifold through-holes 123a and 123b. Accordingly, it is preferable in some embodiments that the third manifold through-holes 122a and 122b communicating with the first main discharge flow field 130 are the third manifold through-holes 122a and 122b for discharging oxygen (air) that is the reaction gas. Further, it is preferable in some embodiments that the fourth manifold through-holes 123a and 123b communicating with the second main discharge flow field 130 are the fourth manifold through-holes 123a and 123b for discharging hydrogen that is the reaction gas.

Next, the position where the discharge flow field 130 can be formed on the sheet frame 100 will be described in detail.

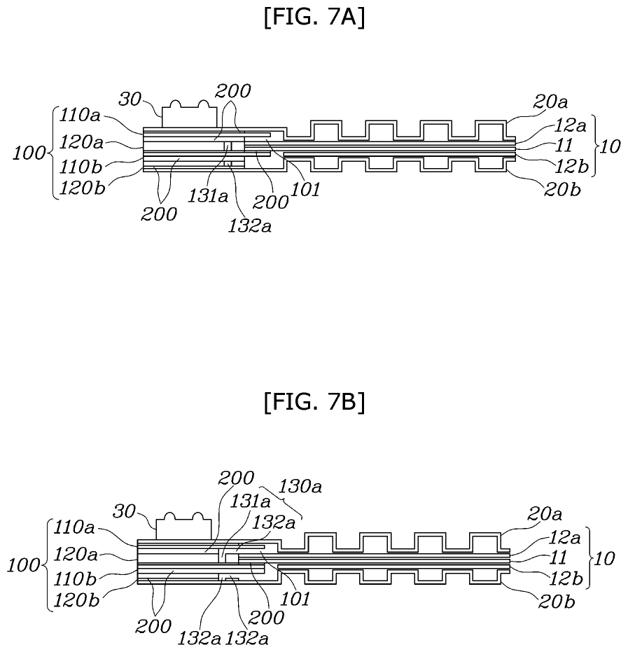

As illustrated in FIGS. 4A, 4B, 7A, and 7B, at the edge in the width direction of the sheet frame 100, an adhesive area that is adhered to a pair of separation plates 20a and 20b can be formed along the length direction. It is preferable in some embodiments that the adhesive area is formed on a non-reaction area where chemical reaction of hydrogen and oxygen does not occur.

In particular, it is preferable in some embodiments that, on any one separation plate 20b of the pair of separation plates 20a and 20b, a sealing gasket 30, which surrounds the area where the insert 10 is located, is provided in the adhesive area of the sheet frame 100.

The sealing gasket 30 can be provided to form sealing of outer gases and cooling water in the unit cell structure.

Accordingly, it is preferable in some embodiments that the discharge flow field 130 is formed inside the adhesive area of the sheet frame 100, and in particular, it is preferable in some embodiments that the discharge flow field 130 is formed in the area between an outmost angle of the insert 10 and the position where the sealing gasket 30 is provided.

The sheet frame 100 and the pair of separation plates 20a and 20b can be adhered to each other by the adhesive member 200 in the adhesive area, and because a part capable of directly pressing the separation plates 20a and 20b can exist for improvement of an adhesive force, it is preferable in some embodiments to provide an adhesive area in an area excluding the area where the sealing gasket 30 is provided.

If the discharge flow field 130 is formed up to the position where the sealing gasket 30 is provided during stack fastening, there can be a possibility that the cross section of the discharge flow field 130 becomes narrower by the repulsive force of the sealing gasket 30 and the driving temperature, and thus it is preferable in some embodiments that the formation position of the discharge flow field 130 is limited to being between the outermost angle of the insert 10 and the position where the sealing gasket 30 is provided.

Although embodiments of the present disclosure has been described with reference to the accompanying drawings, the present disclosure is not necessarily limited thereto. Accordingly, those of ordinary skill in the art to which the present disclosure pertains can appreciate that various modifications and corrections can be possible without departing from the technical ideas of the claims.

What is claimed is:

1. A unitized unit cell of a fuel cell stack, the unitized unit cell comprising:
an insert composed of a membrane-electrode assembly in which a first electrode layer is formed on a first surface of a polymer electrolyte membrane and a second electrode layer is formed on a second surface of the polymer electrolyte membrane, the first surface being opposite the second surface, a first gas diffusion layer on the first surface of the membrane-electrode assembly, and a second gas diffusion layer on the second surface of the membrane-electrode assembly;
a sheet frame comprising a plurality of sheets bonded together, configured to surround a border of the insert in an outer area of the insert, bonded at the border of the insert and an interface thereof, and having a discharge flow field formed therein along a length direction proximate an edge in a width direction to discharge generated water generated from the insert; and
a pair of separation plates having flow fields formed on both surfaces of the sheet frame and configured to supply a reaction gas and to discharge the generated water generated by a reaction.

2. The cell of claim 1, wherein the plurality of sheets of the sheet frame is composed of:
a first base sheet and a second base sheet, each having a base sheet center area on which a first insert through-hole is configured as a border for seating the insert; and
a first flow field sheet bonded between the first base sheet and the second base sheet, the first flow field sheet having a field sheet center area on which a second insert through-hole communicating with the first insert through-hole is formed,
wherein the discharge flow field is formed on the first flow field sheet.

3. The cell of claim 2, wherein on the first base sheet and the second base sheet, a plurality of first manifold through-holes are formed on a first base sheet side in the length direction based on the first insert through-hole and configured to make a reaction gas and a cooling water flow in and out, and a plurality of second manifold through-holes are formed on a second base sheet side in the length direction and configured to make the reaction gas and the cooling water flow in and out,
wherein on the first flow field sheet, a plurality of third manifold through-holes communicating with the plurality of first manifold through-holes are formed on a first flow field sheet side in the length direction based on the second insert through-hole, and a plurality of fourth manifold through-holes communicating with the second manifold through-holes are formed on a second flow field sheet side in the length direction, and
wherein the discharge flow field comprises a first discharge flow field communicating with any one of the plurality of third manifold through-holes from a position that is adjacent to the second insert through-hole on the first flow field sheet.

4. The cell of claim 3, wherein the first gas diffusion layer faces the first electrode layer of the membrane-electrode assembly and the second gas diffusion layer faces the second electrode layer of the membrane-electrode assembly,
wherein the pair of separation plates comprises a first separation plate facing the first gas diffusion layer and a second separation plate facing the second gas diffusion layer, and
wherein the first discharge flow field communicates with any one of the plurality of first manifold through-holes in an area where the first gas diffusion layer and the first separation plate come in contact with each other.

5. The cell of claim 4, wherein the first discharge flow field comprises a first main discharge flow field formed along the length direction proximate the edge in the width direction of the sheet frame and having an end part communicating with any one of the plurality of third manifold through-holes, and
wherein a plurality of first branched discharge flow fields spaced apart at a selected interval from the first main discharge flow field along the length direction and branched toward the second insert through-hole.

6. The cell of claim 5, wherein the first main discharge flow field communicates with the third manifold through-hole positioned at a lowermost end based on a gravity direction among the plurality of third manifold through-holes.

7. The cell of claim 2, wherein the second insert through-hole is formed so that a hole edge thereof is larger than the first insert through-hole as much as a selected width,
wherein a step part is formed as much as a thickness of the first flow field sheet due to a size difference between the second insert through-hole and the first insert through-hole as the first base sheet, the second base sheet, and the first flow field sheet are bonded; and
wherein an insert edge of the insert is bonded onto the step part.

8. The cell of claim 1, wherein on any one of the pair of separation plates, a sealing gasket surrounds the insert, and
wherein the discharge flow field is formed between an outermost angle of the insert and a position where the sealing gasket is provided.

9. The cell of claim 1, wherein the sheet frame is formed of an engineering plastic or a super engineering plastic having a thermal expansion coefficient equal to or smaller than 40.

10. A unitized unit cell of a fuel cell stack, the unitized unit cell comprising:
an insert composed of a membrane-electrode assembly in which a first electrode layer is formed on a first surface of a polymer electrolyte membrane and a second electrode layer is formed on a second surface of the polymer electrolyte membrane, the first surface being opposite the second surface, a first gas diffusion layer on the first surface of the membrane-electrode assembly, and a second gas diffusion layer on the second surface of the membrane-electrode assembly;
a sheet frame comprising a plurality of sheets bonded together, configured to surround a border of the insert in an outer area of the insert, bonded at the border of the insert and an interface thereof, and having a discharge flow field formed therein along a length direction proximate an edge in a width direction to discharge generated water generated from the insert; and
a pair of separation plates having flow fields formed on both surfaces of the sheet frame and configured to supply a reaction gas and to discharge the generated water generated by a reaction,
wherein the plurality of sheets of the sheet frame is composed of:
a first base sheet and a second base sheet, each having a base sheet center area on which a first insert through-hole is configured as a border for seating the insert; and
a first flow field sheet and a second flow field sheet, each having a field sheet center area on which a second insert through-hole communicating with the first insert through-hole is formed,
wherein the first flow field sheet is bonded between the first base sheet and the second base sheet,
wherein the second flow field sheet is bonded onto an outer surface of the second base sheet, and
wherein the discharge flow field comprises a first discharge flow field formed on the first flow field sheet and a second discharge flow field formed on the second flow field sheet.

11. The cell of claim 10, wherein on each of the first base sheet and the second base sheet, a plurality of first manifold through-holes are formed on a first sheet side in the length direction based on the first insert through-hole and configured to make a reaction gas and a cooling water flow in and out, and a plurality of second manifold through-holes are formed on a second sheet side in the length direction and configured to make the reaction gas and the cooling water flow in and out;
wherein, on each of the first flow field sheet and the second flow field sheet, a plurality of third manifold through-holes communicating with the plurality of first manifold through-holes are formed on a first field sheet side in the length direction based on the second insert through-hole, and a plurality of fourth manifold through-holes communicating with the second manifold through-holes are formed on a second field sheet side in the length direction; and
wherein the discharge flow field comprises a first discharge flow field communicating with any one of the plurality of third manifold through-holes from a position that is adjacent to the second insert through-hole on the first flow field sheet, and a second discharge flow field communicating with any one of the plurality of fourth manifold through-holes from a position that is adjacent to the second insert through-hole on the second flow field sheet.

12. The cell of claim 11, wherein the first gas diffusion layer faces the first electrode layer of the membrane-electrode assembly and the second gas diffusion layer faces the second electrode layer of the membrane-electrode assembly,
wherein the pair of separation plates comprises a first separation plate facing the first gas diffusion layer and a second separation plate facing the second gas diffusion layer,
wherein the first discharge flow field communicates with any one of the plurality of third manifold through-holes in an area where the first gas diffusion layer and the first separation plate come in contact with each other, and
wherein the second discharge flow field communicates with any one of the plurality of fourth manifold through-holes in an area where the second gas diffusion layer and the second separation plate come in contact with each other.

13. The cell of claim 12, wherein the first discharge flow field comprises:
a first main discharge flow field formed along the length direction proximate the edge in the width direction of the sheet frame and having an end part communicating with any one of the plurality of third manifold through-holes; and
a plurality of first branched discharge flow fields spaced apart at a predetermined interval from the first main discharge flow field along the length direction and branched toward the second insert through-hole, and
wherein the second discharge flow field is divided into:
a second main discharge flow field formed along the length direction at an edge in the width direction of the sheet frame and having an end part communicating with any one of the plurality of fourth manifold through-holes; and
a plurality of second branched discharge flow fields spaced apart at a predetermined interval from the second main discharge flow field along the length direction and branched toward the second insert through-hole.

14. The cell of claim 13, wherein the first main discharge flow field communicates with the third manifold through-hole positioned at a lowermost end based on a gravity direction among the plurality of third manifold through-holes, and
wherein the second main discharge flow field communicates with the fourth manifold through-hole positioned at a lowermost end based on the gravity direction among the plurality of fourth manifold through-holes.

15. The cell of claim 10, wherein the first discharge flow field and the second discharge flow field are independently formed at positions opposite to each other based on the second base sheet.

16. The cell of claim 10, wherein on any one of the pair of separation plates, a sealing gasket surrounds the insert, and
wherein the discharge flow field is formed between an outermost angle of the insert and a position where the sealing gasket is provided.

17. The cell of claim 10, wherein the sheet frame is formed of an engineering plastic or a super engineering plastic having a thermal expansion coefficient equal to or smaller than 40.
